(19) United States
(12) Patent Application Publication
(10) Pub. No.: US 2024/0239275 A1
(43) Pub. Date: Jul. 18, 2024

(54) VEHICLE INTERIOR COMPONENT HAVING HIGH SURFACE ENERGY BONDING INTERFACE AND METHODS OF FORMING SAME

(71) Applicant: Corning Incorporated, Corning, NY (US)

(72) Inventors: Jen-Chieh Lin, San Jose, CA (US); Arlin Lee Weikel, Mansfield, PA (US)

(21) Appl. No.: 18/289,822

(22) PCT Filed: May 13, 2022
(86) PCT No.: PCT/US2022/029103

§ 371 Date: Nov. 7, 2023

Related U.S. Application Data
(60) Provisional application No. 63/189,943, filed on May 18, 2021.

(51) Int. Cl. B60R 13/02; B60K 35/50; C03B 23/00; C03B 23/035; C03C 17/00

(52) U.S. Cl. CPC B60R 13/0262; B60K 35/50; C03B 23/006; C03B 23/0357; C03C 17/005; B60K 2360/693; B60R 2013/0287; C03C 2218/119

(57) ABSTRACT

Disclosed is a method of forming a vehicle interior component. In the method, a glass article is arranged on a forming surface of a forming surface. The glass article has a first major surface and a second major surface. The first major surface faces the forming surface, and the second major surface is opposite to the first major surface. The second major surface includes a region having a surface free energy of at least 35 mN/m. An adhesive is applied to the region of the second major surface of the glass article. The adhesive is contacted with a frame to attach the frame to the glass article.

### CROSS REFERENCE TO RELATED APPLICATIONS

This application claims the benefit of priority under 35 U.S.C. § 119 of U.S. Provisional Application Ser. No. 63/189,943, filed on May 18, 2021, the content of which is relied upon and incorporated herein by reference in its entirety.

### BACKGROUND

The disclosure relates to a vehicle interior component and, more particularly, to a vehicle interior component have a high surface free energy bonding interface without the use of a chemical primer.

Vehicle interiors include curved surfaces and can incorporate displays in such curved surfaces. The materials used to form such curved surfaces are typically limited to polymers, which do not exhibit the durability and optical performance as glass. As such, curved glass sheets are desirable, especially when used as covers for displays. Existing methods of forming such curved glass sheets, such adhering a glass sheet to a frame, have drawbacks because the glass sheet needs to be prepared with a chemical primer. Chemical primers can be subject to various environmental regulations that restrict where such chemical primers can be used, potentially creating a disruption in a manufacturing process and increasing the cost to manufacture a vehicle interior component. Accordingly, Applicant has identified a need for vehicle interior systems that can incorporate a curved glass sheet in a cost-effective manner and without problems typically associated with conventional forming processes that utilize chemical primers.

### SUMMARY

According to an aspect, embodiments of the disclosure relate to a method of forming a vehicle interior component. The glass article has a first major surface and a second major surface. The second major surface includes a region having a surface free energy of at least 35 mN/m. A frame is attached to the second major surface of the glass article. In one or more embodiments, an adhesive is applied to the region of the second major surface of the glass article and the adhesive is contacted with a frame to attach the frame to the glass article.

In one or more embodiments of the method, a glass article is arranged on a forming surface. In one or more particular embodiments, the first major surface faces the forming surface, and the second major surface is opposite to the first major surface.

According to another aspect, embodiments of the disclosure relate to a kit for a vehicle interior component. The kit includes a glass article having a first major surface and a second major surface. The second major surface is opposite to the first major surface, and the second major surface includes a region with a surface free energy of at least 35 mN/m. The kit also includes a frame configured to be adhered or attached to the second major surface of the glass article.

According to still another aspect, embodiments of the disclosure relate to a vehicle interior component. The vehicle interior component includes a glass article having a first major surface and a second major surface. The second major surface is opposite to the first major surface, and the second major surface includes a region with a surface free energy of at least 35 mN/m. A frame is attached to the second major surface of the glass article. In one or more embodiments, an adhesive layer directly contacts the region of the glass article, and a frame is attached to the second major surface of the glass article by the adhesive layer.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the description serve to explain principles and operation of the various embodiments.

FIG. 1 is a perspective view of a vehicle interior with vehicle interior systems, according to exemplary embodiments.

FIG. 2 depicts a V-shaped vehicle interior component, according to an exemplary embodiment.

FIG. 3 depicts a detail view of a portion of the V-shaped interior component of FIG. 2, according to an exemplary embodiment.

FIG. 4 depicts a C-shaped vehicle interior component, according to an exemplary embodiment.

FIG. 5 depicts an exploded perspective view of a vehicle interior component positioned over a forming surface, according to an exemplary embodiment.

FIG. 6 depicts a cross-section of a vehicle interior component with display units, according to an exemplary embodiment.

FIGS. 7-9 depict graphs of contact angles and surface free energy for glass articles that have undergone plasma treatment at various scan speeds, according to exemplary embodiments.

FIG. 10 depicts a plot of the water contact angle against surface free energy, according to an exemplary embodiment.

FIG. 11 depicts an experimental setup for conducting a shear stress test of an adhesive layer according to ASTM D1002.

FIGS. 12 and 13 depict graphs of shear strength for glass articles having two different ink layers as measured according to the experimental setup of FIG. 11 for a primer treated glass article, an untreated glass article, and plasma treated glass articles, according to exemplary embodiments.

FIG. 14 depicts geometric dimensions of a glass sheet of a glass article, according to an exemplary embodiment.

### DETAILED DESCRIPTION

Reference will now be made in detail to various embodiments, examples of which are illustrated in the accompanying drawings. In general, the present disclosure is directed to vehicle interior components having a frame attached to a glass article without the use of a chemical primer to promote adhesion. As will be described hereinbelow, the use of chemical primers can be avoided by providing an attaching surface of the glass article that has a high surface free energy. According to exemplary embodiments, a high surface free energy can be provided by plasma treating the attaching surface of the glass article instead of using a chemical primer. Industrial chemical primers are often subject to environmental regulations that restrict geographic locations where such primers can be used, potentially leading to the division of manufacturing steps across multiple facilities. In contrast, plasma treating, for example, does not implicate the same environmental regulations associated with chemical primers, and plasma treating systems can be integrated in line with the rest of the manufacturing process for producing the vehicle interior component. These and other aspects and advantages will be described in relation to the embodiments provided below and in the drawings. These embodiments are presented by way of example and not by way of limitation.

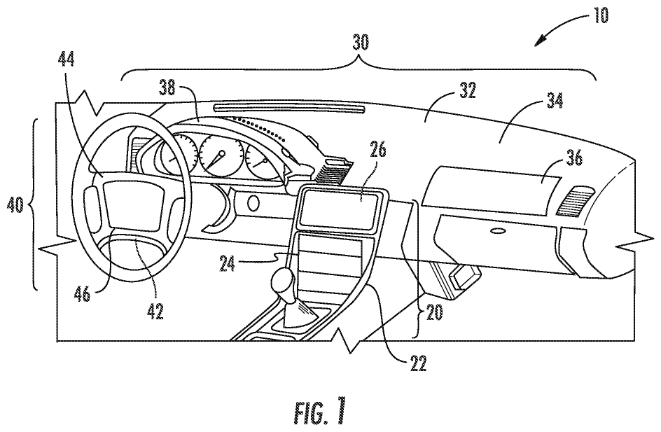

FIG. 1 shows an exemplary interior 10 of a vehicle that includes three different embodiments of vehicle interior systems 20, 30, 40. Vehicle interior system 20 includes a base, shown as center console base 22, with a surface 24 including a display 26. Vehicle interior system 30 includes a base, shown as dashboard base 32, with a surface 34 including a display 36. The dashboard base 32 typically includes an instrument panel 38 which may also include a display. Vehicle interior system 40 includes a base, shown as steering wheel base 42, with a surface 44 and a display 46. In one or more embodiments, the vehicle interior system includes a base that is an arm rest, a pillar, a seat back, a floor board, a headrest, a door panel, or any portion of the interior of a vehicle that includes a curved surface. In embodiments, one or more of the surfaces 24, 34, 44 is curved. In embodiments, one or more of the surfaces 24, 34, 44 is flat or planar.

The embodiments of the vehicle interior components described herein can be used as displays 26, 36, 38, 46 in each of vehicle interior systems 20, 30, 40, among others. In such embodiments, the vehicle interior component discussed herein may include a cover glass sheet that also covers non-display surfaces of the dashboard, center console, steering wheel, door panel, etc. In such embodiments, the glass material may be selected based on its weight, aesthetic appearance, etc. and may be provided with a coating (e.g., an ink or pigment coating) including a pattern (e.g., a brushed metal appearance, a wood grain appearance, a leather appearance, a colored appearance, etc.) to visually match the glass components with adjacent non-glass components. In specific embodiments, such ink or pigment coating may have a transparency level that provides for deadfront or color matching functionality when the display 26, 36, 38, 46 is inactive. Further, while the vehicle interior of FIG. 1 depicts a vehicle in the form of an automobile (e.g., cars, trucks, buses and the like), the vehicle interior components disclosed herein can be incorporated into other vehicles, such as trains, sea craft (boats, ships, submarines, and the like), aircraft (e.g., drones, airplanes, jets, helicopters and the like), and spacecraft.

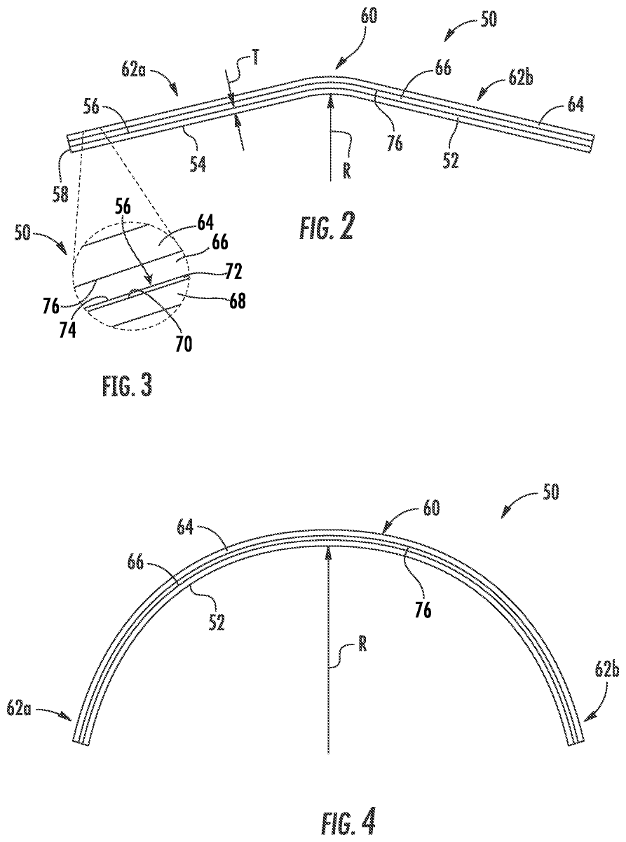

In embodiments, the surfaces 24, 34, 44 can be any of a variety of curved shapes, such as V-shaped or C-shaped as shown in FIGS. 2 and 4, respectively. Referring first to FIG. 2, a side view of an embodiment of a V-shaped vehicle interior component 50 is shown. The vehicle interior component 50 includes a glass article 52 having a first major surface 54, a second major surface 56 opposite to the first major surface 54, and a minor surface 58 joining the first major surface 54 to the second major surface 56. The first major surface 54 and the second major surface 56 define a thickness T of the glass article 52. In embodiments, the thickness T of the glass article 52 is from 0.3 mm to 2 mm, in particular 0.5 mm to 1.1 mm. In a vehicle, the first major surface 54 faces the occupants of the vehicle.

In embodiments, the first major surface 54 and/or the second major surface 56 may comprise a glass surface. In other embodiments, the first major surface 54 and/or the second major surface 56 may comprise one or more surface treatments. Examples of surface treatments that may be applied to one or both of the first major surface 54 and second major surface 56 include at least one of an anti-glare coating, an anti-reflective coating, a coating providing touch functionality, a decorative (e.g., ink or pigment) coating, or an easy-to-clean coating. In embodiments, the one or more surface treatments comprise the entire first major surface 54 and/or second major surface 56, respectively. In other embodiments, the one or more surface treatments comprise less than the entire first major surface 54 and/or second major surface 56, respectively. For example, the surface treatment may be present only as a border around the glass article 52, or in another example, the surface treatment may be present only where a display unit is to be mounted.

As can be seen in FIG. 2, the glass article 52 has a curved region 60 disposed between a first flat section 62a and a second flat section 62b. Further, as shown in FIG. 2, the curved region 60 defines a concave curve with respect to the first major surface 54, but in other embodiments, the curved region 60 is instead a convex curve with respect to the first major surface 54. The curved region 60 is defined by a radius of curvature R. In embodiments, the radius of curvature R can be as low as 30 mm or up to 10,000 mm.

In the vehicle interior component 50 of FIG. 2, a frame 64 is attached to the second major surface 56 of the glass article 52. The frame 64 is attached to the glass article 52 via an adhesive layer 66. In embodiments, the adhesive layer 66 joining the frame 64 to the glass article 52 is a structural adhesive, such as at least one of a toughened epoxy, a flexible epoxy, an acrylic, a silicone, a urethane, a polyurethane, or a silane modified polymer. In embodiments, the adhesive layer 66 has a thickness of 2 mm or less between the frame 64 and the glass article 52. As disclosed herein, the adhesive layer 66 is applied (either to the glass article 52 or frame 64) so that the adhesive layer 66 directly contacts the second major surface 56 of the glass article 52 when the vehicle interior component 50 is assembled. In particular, no chemical primer is applied to the second major surface 56 to prepare the glass article 52 for bonding to the adhesive layer 66. In one or more embodiments, the frame 64 is further attached to the glass article 52 via mechanical fasteners (not shown).

In certain conventional vehicle interior components, proper bonding of the adhesive layer required that a chemical primer be applied to the second major surface before application of the adhesive layer. The use of such primers can implicate various environmental regulations that restrict the locations in which the primer can be used or require specialized equipment for application and disposal. These requirements associated with the use of a chemical primer increase the cost of the manufacturing process and can potentially require the manufacturing process to be split between multiple locations. Accordingly, elimination of primer in the manufacturing process is expected to decrease manufacturing cost and improve manufacturing efficiency by avoiding costly environmental compliance and by allowing manufacturing to take place in a single facility, in particular on a single line.

According to embodiments of the present disclosure, the use of a chemical primer in the manufacturing process is avoided by providing a second major surface 56 that has a high surface free energy. In one or more embodiments, the surface free energy of the second major surface 56 is at least 35 mN/m. While not particularly limited on the high side, the surface free energy of the second major surface 56 can be up to 80 mN/m in one or more embodiments. In embodiments, the surface free energy of the second major surface 56 is in a range from about 35 mN/m to about 80 mN/m, from about 40 mN/m to about 80 mN/m, from about 45 mN/m to about 80 mN/m, from about 50 mN/m to about 80 mN/m, from about 55 mN/m to about 80 mN/m, from about 60 mN/m to about 80 mN/m, from about 65 mN/m to about 80 mN/m, from about 70 mN/m to about 80 mN/m, from about 75 mN/m to about 80 mN/m, from about 35 mN/m to about 75 mN/m, from about 35 mN/m to about 70 mN/m, from about 35 mN/m to about 65 mN/m, from about 35 mN/m to about 60 mN/m, from about 35 mN/m to about 55 mN/m, from about 35 mN/m to about 50 mN/m, from about 35 mN/m to about 45 mN/m, from about 35 mN/m to about 40 mN/m, from about 40 mN/m to about 75 mN/m, from about 45 mN/m to about 75 mN/m, from about 50 mN/m to about 75 mN/m, from about 55 mN/m to about 75 mN/m, from about 60 mN/m to about 75 mN/m, from about 65 mN/m to about 75 mN/m, from about 70 mN/m to about 75 mN/m, from about 40 mN/m to about 70 mN/m, from about 40 mN/m to about 65 mN/m, from about 40 mN/m to about 60 mN/m, from about 40 mN/m to about 55 mN/m, from about 40 mN/m to about 50 mN/m, from about 40 mN/m to about 45 mN/m, from about 45 mN/m to about 70 mN/m, from about 50 mN/m to about 70 mN/m, from about 55 mN/m to about 70 mN/m, from about 60 mN/m to about 70 mN/m, from about 65 mN/m to about 70 mN/m, from about 45 mN/m to about 65 mN/m, from about 45 mN/m to about 60 mN/m, from about 45 mN/m to about 55 mN/m, from about 45 mN/m to about 50 mN/m, from about 50 mN/m to about 65 mN/m, from about 55 mN/m to about 60 mN/m, from about 50 mN/m to about 60 mN/m, or any ranges or subranges therebetween.

FIG. 3 is a detail schematic depiction of the vehicle interior component 50. The glass article 52 includes at least a glass sheet 68. If the glass article 52 includes only a glass sheet 68, then the second major surface 56 is a glass surface 70. In other embodiments, the glass article 52 also includes a colorant layer 72 disposed over the glass sheet 68. The colorant layer 72 includes dyes or pigments that impart a decorative and/or functional aspect to the glass article 52. In one or more embodiments, the colorant layer 72 provides a black matrix border along the periphery of the glass article. For example, and as mentioned above, a colorant layer 72 may be provided on the glass article to provide a deadfront feature that blends the glass sheet 68 (i.e., cover glass) into the surrounding surface. Such colorant layer 72 may, for example, resemble wood grain, leather, carbon fiber, or brushed metal. When a display is activated, the brightness of the display shows through the colorant layer 72 to be visible through the glass sheet 68. In other embodiments, the colorant layer 72 may be a solid color, such as a solid color border or a color matching surface, to hide the display or its surrounding electrical connections. In embodiments of the glass article 52 including a colorant layer 72, the second major surface 56 is a colorant surface 74. In embodiments, the colorant layer 72 is an ink layer. In embodiments, the colorant layer 72 comprises a thickness of 1 μm to 20 μm, in particular about 7 μm to 9 μm.

In general, a glass surface 70 or colorant surface 74 does not have sufficient surface free energy to form a strong bond with the adhesive layer 66. To provide a strong bond, the glass surface 70 or colorant surface 74 may be treated or selected to have a desirable level of surface free energy (i.e., 35 mN/m or more) for the second major surface 56. In an embodiment, the surface free energy of the glass surface 70 or the colorant surface 74 is treated with plasma to provide the desired level of surface free energy. In a particular embodiment, the plasma treatment is an atmospheric plasma treatment. In another embodiment, the colorant layer 72 is selected so that the dried or cured colorant surface 74 has the desired level of surface free energy.

When the second major surface 56 is provided with the desired surface free energy, the adhesive layer 66 is applied to the second major surface 56. Thereafter, the frame 64 is moved into contact with the adhesive layer 66 so that the adhesive layer 66, after any necessary curing, bonds the frame 64 to the glass article 52. In other embodiments, the adhesive layer 66 may instead be applied to the frame 64, and the frame 64 may be moved so that the adhesive layer 64 contacts the region of the second major surface 56 having the desired surface free energy. In part, the frame 64 facilitates mounting the vehicle interior component 50 to a vehicle interior base (such as center console base 22, dashboard base 32, and/or steering wheel base 42 as shown in FIG. 1). Additionally, for curved vehicle interior components, the frame 64 has a frame support surface 76 that holds the glass article 52 in a curved shape (at least in the curved region 60) via the bond created by the adhesive layer 66. In one or more embodiments, the glass article 52 is formed in such a way that the curved region 60 is not permanent. That is, the glass article 52 would spring back to a planar, non-curved (i.e., flat) configuration if the glass article 52 was not attached to the frame 64. Thus, the glass article 52 is stressed to produce the curvature and remains stressed during the life of the vehicle interior component 50.

FIG. 4 depicts another embodiment of a vehicle interior component 50, in particular a C-shaped vehicle interior component 50. As compared to the V-shaped vehicle interior component 50 of FIG. 2, the C-shaped vehicle interior component 50 of FIG. 4 has a larger curved region 60 and shorter flat sections 62a, 62b. The V-shape and C-shape are but two examples of curved vehicle interior components 50. In other embodiments, the vehicle interior components 50 can include curved regions 60 having opposing curvatures to create an S-shape, a curved region 60 followed by a flat section 62a to create a J-shape, and curved regions 60 separated by a flat section 62a to create a U-shape, among others. Further, while the curved regions 60 and flat sections 62a, 62b are depicted as being symmetrical, the curved regions 60 and flat sections 62a, 62b are asymmetrical in other embodiments. For example, one flat section 62a may be longer than the other flat section 62b, or the curvature of a curved region 60 may extend further in one direction than another.

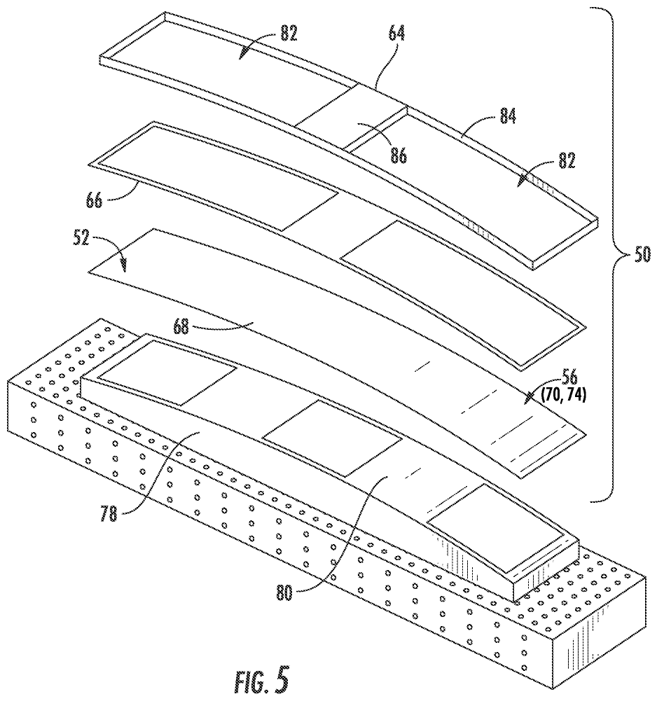

In embodiments, the vehicle interior components 50 according to the present disclosure are formed by cold-forming techniques. In general, the process of cold-forming involves application of a bending force to the glass article 52 while the glass article 52 is situated on a forming surface 78 as shown in the exploded view of FIG. 5. As can be seen, the forming surface 78 has a curved forming surface 80, and the glass article 52 is bent into conformity with the curved forming surface 80. In embodiments, the glass article 52 is held into conformity with the curved forming surface 80 of the forming surface 78 using vacuum pressure (e.g., pulled through a fabricating chuck) and/or mechanical restraints, such as clips or clamps.

Advantageously, it is easier to apply surface treatments and colorant layers 72 to a flat glass sheet 68 prior to creating the curvature in the glass sheet 68, and cold-forming allows the treated glass sheet 68 to be bent without destroying the surface treatment and/or colorant layers 72 (as compared to the tendency of high temperatures associated with hot-forming techniques to destroy surface treatments, which requires surface treatments and colorant layers to be applied to the curved article in a more complicated process). In embodiments, the cold-forming process is performed at a temperature less than the softening temperature of the glass composition of the glass sheet 68. In particular, the cold forming process may be performed at room temperature (e.g., about 20° C.) or a slightly elevated temperature, e.g., at 200° C. or less, 150° C. or less, 100° C. or less, or at 50° C. or less, which may assist with curing of the adhesive layer 66. Further, in embodiments, the cold-forming process may involve an accelerated cure using, e.g., infrared or ultraviolet radiation.

As shown in FIG. 5, the frame 64 is not bonded to the entirety of the second major surface 56. Instead, the frame 64 includes apertures 82 designed to accommodate display units. Thus, in the embodiment depicted, the frame 64 defines a border 84 and a central pillar 86. The adhesive layer 66 is applied in substantially the same shape as the frame 64, and as such, the region of the glass article 52 that is provided with a high surface free energy may be limited to regions where the adhesive layer 66 is provided to attach the frame 64 to the glass article 52.

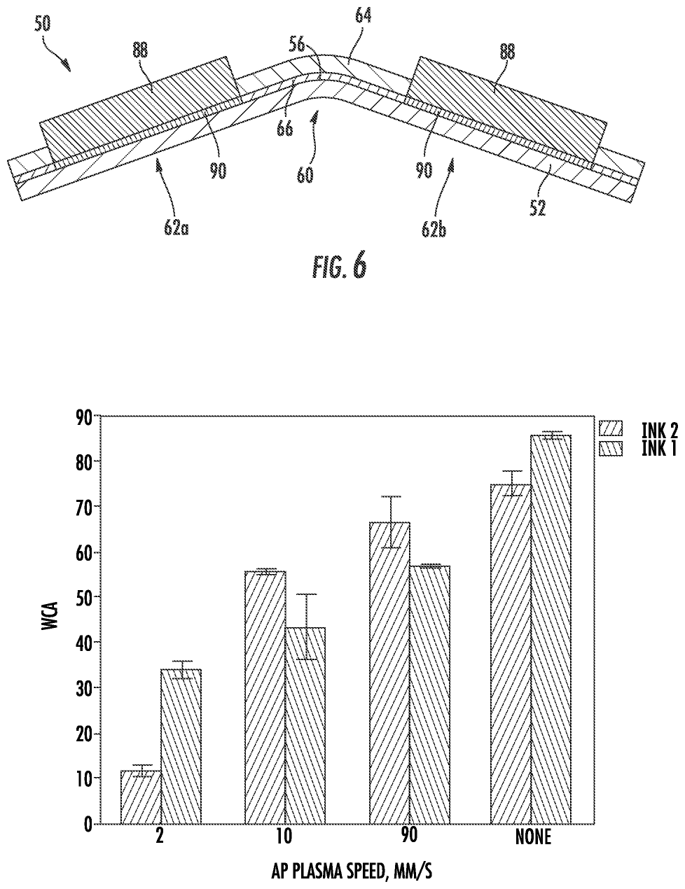

FIG. 6 depicts a cross-section of a vehicle interior component 50 including multiple display units 88. As can be seen in FIG. 6, the display units 88 are disposed on the second major surface 56 of the glass article 52. In embodiments, the display units 88 are adhered to the second major surface 56 of the glass article 52 using an optically clear adhesive 90. In embodiments, the vehicle interior component 50 includes a single display unit 88, and in other embodiments, the vehicle interior component 50 includes two or more display units 88. In one or more embodiments, each display unit 88 is a light emitting diode (LED) display unit, an organic LED (OLED) display unit, a micro-LED display unit, quantum dot display unit (e.g., QLED), liquid crystal display (LCD), or plasma display, among other possibilities. Further, in one or more embodiments, the display unit 88 or display units 88 may be curved, i.e., attached to the glass article 52 in a curved region 60. In embodiments, the display units 88 may be attached to the glass article 52 when the glass article 52 is in the flat configuration, and the display units 88 may be cold-bent with the glass article 52, including bending of the display unit 88, during the cold-forming process described above.

Having described the structure of the vehicle interior component 50, methods of providing a desired surface free energy to regions of the second major surface 56 of the glass article 52 are now described. According to one or more embodiments, the surface free energy of the second major surface 56 can be increased to the desired level using a plasma treatment. During plasma treatment, the second major surface 56 is contacted with plasma, which is a reactive mixture of gas species containing large concentrations of ions, electrons, free radicals, and other neutral species. The plasma may be used to remove contaminants from the second major surface 56 and activate the second major surface 56 by providing reactive functional groups on the second major surface 56. Advantageously, plasma treatment does not create hazardous by-products and is itself environmentally-friendly. Thus, plasma treatments can substantially reduce or completely avoid the environmental concerns associated with conventional chemical primer treatments. In embodiments, the plasma treatment is conducted in a vacuum, and in other embodiments, the plasma treatment is an atmospheric plasma treatment, i.e., conducted outside of a vacuum chamber and at ambient atmospheric pressure.

In particular embodiments, the plasma treatment is an atmospheric plasma treatment. In embodiments, the plasma is radio-frequency capacitive discharge plasma. In embodiments, the plasma treatment is conducted using argon and oxygen as the working gases. In embodiments, the oxygen to argon ratio is 0.1% to 5%. In embodiments, the power setting for the plasma treatment is 10 Watts to 2000 Watts, in particular 150 Watts to 200 Watts. In embodiments, the plasma is applied to the second major surface 56 using a nozzle, in particular a nozzle attached to an automated robot arm. In such embodiments, the working distance of the nozzle from the second major surface 56 is from about 2 mm to about 10 mm. In one or more embodiments in which a nozzle is used to apply the plasma, the nozzle is scanned over the second major surface 56 at a speed of at least 10 mm/s. In embodiments, the speed is up to 90 mm/s, and in still other embodiments, the speed is greater than 90 mm/s.

In a particular embodiment, the plasma treatment was conducted using an Atomflo™ 500 (Surfx Technologies, LLC, Redondo Beach, CA) with a 1″ linear nozzle. Using this system, a variety of experimental samples were prepared. The experimental samples included glass articles 52 having a glass sheet 68 on which a colorant layer 72 was applied. The colorant layer 72 was, in particular, an ink layer. Thus, the second major surface 56 was the colorant surface 74, i.e., an ink surface. The samples were prepared using two different inks (Ink 1 from Merlia Ink & Coating, Shenzen, China, and Ink 2 from Seiko Advance Ltd., Japan). The samples were exposed to a plasma generated from flowing argon and oxygen gas at 20 lpm and 0.3 lpm, respectively, at a power setting of 140 Watts. The working distance between the nozzle and the glass articles was 5 mm. For each sample, the nozzle was scanned over the second major surface 56 at a speed of 2 mm/s, 10 mm/s, or 90 mm/s.

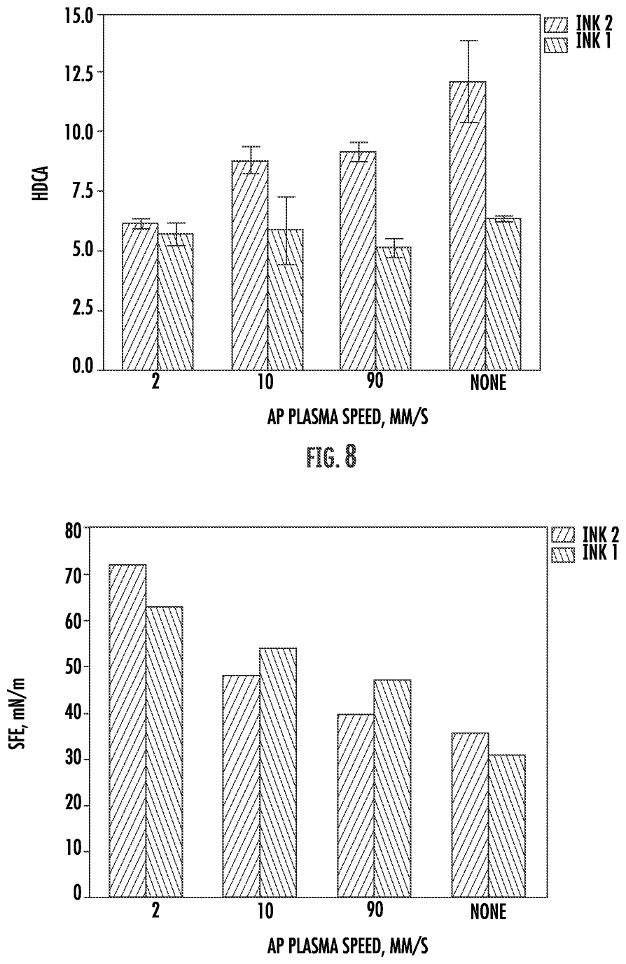

The samples that were plasma treated were mounted on a robot platform using polyimide tape, and the robot was programmed to deliver plasma dosages based on the working distance and scan speeds discussed above. The nozzle was provided with cooling water heated to 60° C. After plasma treatment, the surface free energy was determined using a Krüss DSA100 goniometer. Additionally, contact angles were measured for sessile drops (5 or 6 for each sample) using a polar fluid (deionized water) and a nonpolar fluid (hexadecane). The contact angles were used to determine surface free energy using the OWRK method. FIGS. 7-9 depict graphs of the water contact angle (WCA), contact angle for hexadecane drops (HDCA), and the surface free energy as a function of atmospheric plasma scan speed (AP Plasma Speed). On these graphs in FIGS. 7 and 8, the error bars represent one standard deviation from the average contact angle for the 5 or 6 droplets measured for each sample.

Referring first to FIG. 7, the water contact angle (WCA) for both inks shown. On the right of the graph, the water contact angle for untreated (None) samples with Ink 1 and Ink 2 are shown. Both samples have a water contact angle of greater than about 75°. For adhesive bonding, it is desirable to have a low contact angle because that corresponds to the adhesive wetting the surface, which enhances bonding. As can be seen for the treated samples, the water contact angle decreases with decreasing scan speed. Interestingly, the water contact angle for Ink 1 (about 86°) starts higher than Ink 2 (about 75°) for the untreated sample, but the water contact angle dropped faster for Ink 1 (about 55° and about 43°) than for Ink 2 (about 66° and about 55°) as the scan speeds of 90 mm/s and 10 mm/s. However, the water contact angle for Ink 2 dropped significantly at a scan speed of 2 mm/s to about 12°, whereas the water contact angle for Ink 1 dropped only to about 34°.

FIG. 8 depicts a graph of hexadecane contact angle (HDCA) for samples having Ink 1 and Ink 2. As can be seen from FIG. 8, the HDCA for both inks is substantially lower the respective WCA. Indeed, the HDCA for the untreated samples is about 12.5° for Ink 2 and about 6° for Ink 1. For treated samples, the HDCA stays about the same as the untreated sample for Ink 1 for scan speeds of 90 mm/s, 10 mm/s, and 2 mm/s. For Ink 2, the HDCA drops as the plasma treatment scan speed increases. At a scan speed of 90 mm/s, the HDCA is about 9°, and at a scan speed of 10 mm/s, the HDCA is about 8.5°. At a scan speed of 2 mm/s, the HDCA for Ink 2 is about 6.5°. Using the WCA and HDCA for Inks 1 and 2, the SFE can be calculated using the OWRK method.

FIG. 9 depicts a graph of the surface free energy (SFE) for the untreated samples and samples plasma treated as scan speeds of 90 mm/s, 10 mm/s, and 2 mm/s. The surface free energy was higher for Ink 2 than for Ink 1 in the untreated state. In particular, the surface free energy for the untreated glass article with Ink 2 was about 35 mN/m, whereas the surface free energy for the untreated glass article with Ink 1 was about 31 mN/m. For the treated samples, the glass articles with Ink 1 and Ink 2 followed a similar but opposite trajectory as the WCA in FIG. 7. Namely, Ink 1 reacts more strongly to treatment at 90 mm/s and 10 mm/s, but Ink 2 provides the highest response to treatment at 2 mm/s. In particular, Ink 1 increases in surface free energy from about 31 mN/m in the untreated state, to about 47 mN/m when treated at a scan speed of 90 mm/s, to about 54 mN/m when treated at a scan speed of 10 mm/s, and to about 63 mN/m when treated at a scan speed of 2 mm/s. Ink 2 increases in surface free energy from about 35 mN/m in the untreated state, to about 40 mN/m when treated at a scan speed of 90 mm/s, to about 48 mN/m when treated at a scan speed of 10 mm/s, and to about 72 mN/m when treated at a scan speed of 2 mm/s. Because the WCA directly corresponds to SFE, it would be expected that the SFE of FIG. 9 would follow a similar pattern as the WCA shown in FIG. 7.

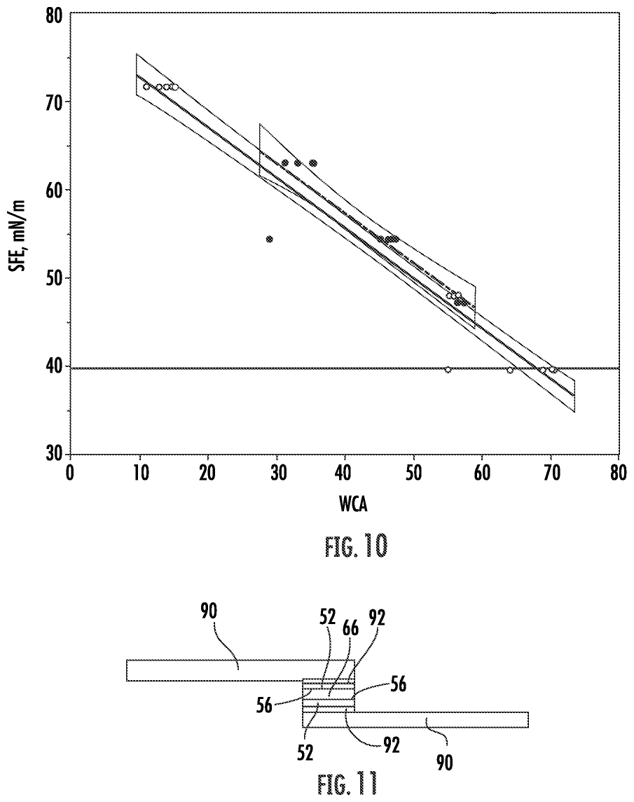

In FIG. 10, each WCA measurement was plotted against the SFE. As mentioned above, 5 or 6 sessile drops were measured for each sample, and the average for each sample was reported in the graph shown in FIG. 7. In FIG. 10, each measurement is depicted as a point on the graph, and a trendline with error margins is shown. As can be seen, the average measured value of the WCA is linearly related to an SFE for Inks 1 and 2. For Ink 1, the relationship between WCA and SFE was found to be SFE=79.93-0.5659WCA. For Ink 2, the relationship between WCA and SFE was found to be SFE=78.22-0.566WCA. Thus, the measured WCA can be used to predict SFE with reasonable accuracy.

The treated and untreated samples discussed above with respect to surface free energy were then used in tests to determine adhesive strength as measured according to ASTM D1002 for a single lap joint. FIG. 11 depicts the experimental setup for determining adhesive strength. As can be seen in FIG. 11, glass articles 52 (including glass sheets having colorant (ink) layers) were bonded to respective top and bottom metal strips 90 using epoxy 92. The second major surfaces 56 of the glass articles were either untreated with plasma or plasma treated at scan speeds of 90 mm/s, 10 mm/s, or 2 mm/s as discussed above. The adhesive layer 66 was applied between opposing glass articles 52 and allowed to cure. For the purposes of comparison, a sample was also prepared in which the second major surfaces of glass articles were treated with chemical primers.

For the adhesive strength testing, the glass articles 52 included glass sheets that were 1″×1″×1.1 mm. The glass material was Corning® Gorilla® Glass. The colorant layers for each sample were screen printed Ink 1 or Ink 2. For the plasma treated and untreated samples, the adhesive (BETASEAL™ X2500, available from Dow Automotive Systems, Auburn Hills, MI) was applied between the glass articles within an hour of plasma treatment. For the chemical primer samples, a glass primer (BETAPRIME™ 43518, available from DuPont de Nemours, Inc., Wilmington, DE) and a blackout glass primer (BETAPRIME™ 43520A, available from DuPont de Nemours, Inc., Wilmington, DE) were applied to the glass articles prior to applying the adhesive. For each test specimen, the adhesive was allowed to cure for 7 days before testing. Thereafter, the specimens were tested to determine adhesive shear strength according to ASTM D1002.

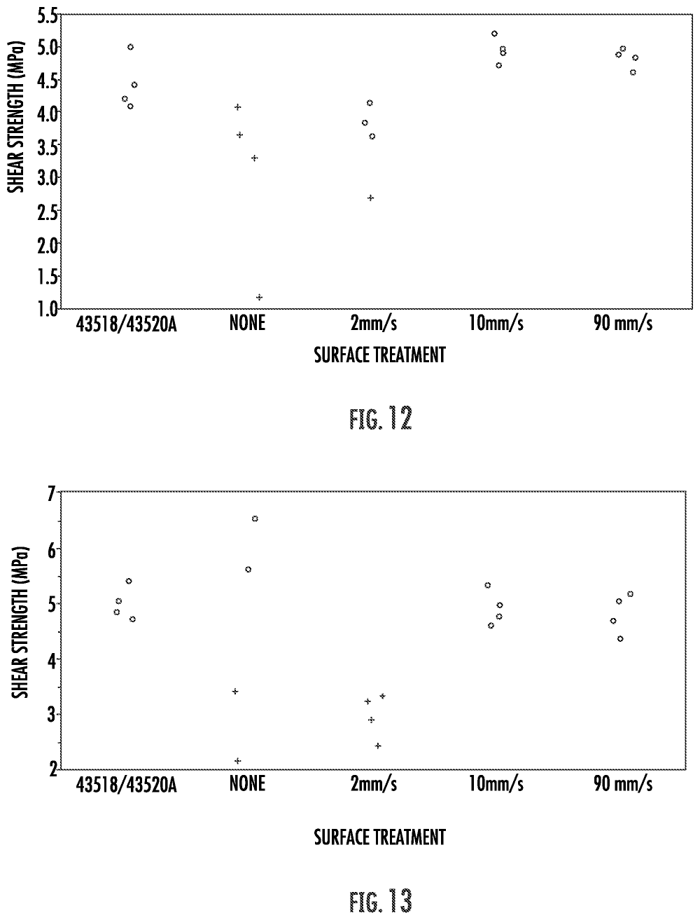

FIGS. 12 and 13 display the test results for Ink 2 and Ink 1, respectively. The chemical primer examples provide a conventional baseline for performance. As can be seen in FIG. 12, the chemical primer specimens exhibited an adhesive shear strength greater than 4 MPa with one specimen having a shear strength of about 5 MPa. All of the specimens exhibited cohesive failure of the adhesive. That is, none of the specimens exhibited adhesive failure of the bond between the adhesive and the glass articles. For the specimens that were not plasma treated or chemically primed, all of the specimens exhibited mixed cohesive and adhesive failure with three of the specimens failing between about 3 MPa and about 4 MPa. For the specimens that were plasma treated at scan speeds of 90 mm/s and 10 mm/s, all exhibited a shear strength above 4.5 MPa with multiple specimens exhibiting a shear strength approximately at or above 5 MPa. Further, all of these specimens exhibited cohesive failure of the adhesive layer. For the specimens treated with plasma at a scan speed of 2 mm/s, the shear strength was similar to the untreated/unprimed specimens. While three of the four specimens exhibited cohesive failure, one specimen exhibited mixed cohesive and adhesive failure.

FIG. 12 demonstrates that it appears possible to over-treat the second major surface. In particular, while a 2 mm/s scan speed provided the highest dosage of plasma for the samples tested, the inventors surmise that the high plasma dosage may have physically damaged the ink on the second major surface and/or increased surface roughness too much, inhibiting bonding with the adhesive.

FIG. 13, showing the shear strength for the adhesive bonded to the glass articles including a layer of Ink 1, substantially agrees with the results shown in FIG. 12. As can be seen in FIG. 13, the specimens on which chemical primer was applied exhibited shear strength between 4.5 MPa and 5.5 MPa, and all specimens cohesively failed. The specimens that were not plasma treated and were not chemically primed exhibited a wide range of shear strengths between about 2 MPa and about 6.5 MPa. Two of the untreated/unprimed specimens exhibited mixed cohesive and adhesive failure mode. Such unpredictable failure strengths and modes are undesirable for producing a consistent product with reproducible properties. The specimens treated with plasma at scan speeds of 90 mm/s and 10 mm/s mostly exhibited shear strengths in the range of 4.5 MPa to 5.5 MPa, and each specimen exhibited cohesive failure mode. The specimens treated with plasma at a scan speed of 2 mm/s again demonstrated the lowest average shear strength with all specimens failing below 3.5 MPa and exhibited mixed cohesive and adhesive failure.

FIGS. 12 and 13 demonstrate that plasma treatment performs just as well if not better than the use of primer for improving adhesion between the second major surface of the glass article and the adhesive layer. Further, plasma treatment does not present the same environmental concerns as chemical adhesive primer, and plasma treatment can be implemented in automated processes using currently-available industrial systems. Additionally, the plasma treatment can be applied to the glass article in the flat configuration and lasts for up to four hours in embodiments, allowing time to transport the glass articles to various stages of the cold forming process.

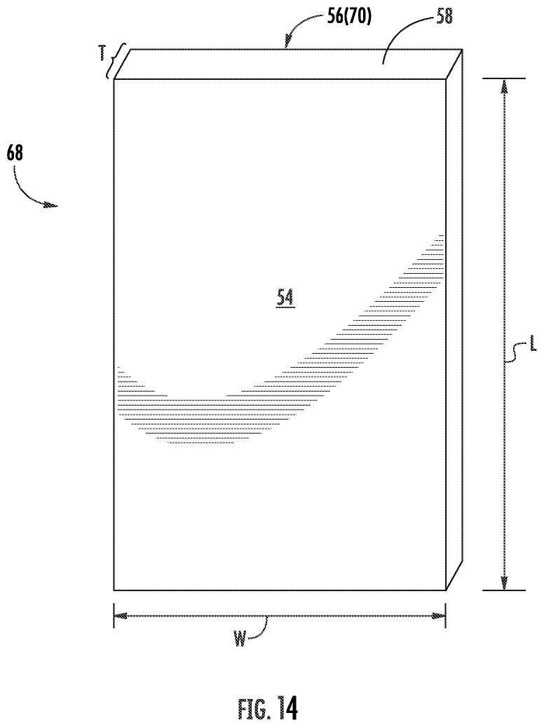

Referring to FIG. 14, additional structural details of a glass sheet 68 of the glass article 52 are shown and described. As noted above, glass sheet 68 has a thickness T that is substantially constant and is defined as a distance between the first major surface 54 and the second major surface 56. In various embodiments, T may refer to an average thickness or a maximum thickness of the glass sheet. In addition, glass sheet 68 includes a width W defined as a first maximum dimension of one of the first or second major surfaces 54, 56 orthogonal to the thickness T, and a length L defined as a second maximum dimension of one of the first or second major surfaces 54, 56 orthogonal to both the thickness and the width. In other embodiments, W and L may be the average width and the average length of glass sheet 68, respectively.

In various embodiments, average or maximum thickness T is in the range of 0.3 mm to 2 mm. In various embodiments, width W is in a range from 5 cm to 250 cm, and length L is in a range from about 5 cm to about 1500 cm. As mentioned above, the radius of curvature at the midpoint (e.g., R as shown in FIGS. 2 and 4) of glass sheet 68 is about 30 mm to about 1000 mm.

In embodiments, the glass sheet 68 may be strengthened. In one or more embodiments, glass sheet 68 may be strengthened to include compressive stress that extends from a surface to a depth of compression (DOC). The compressive stress regions are balanced by a central portion exhibiting a tensile stress. At the DOC, the stress crosses from a positive (compressive) stress to a negative (tensile) stress.

In various embodiments, glass sheet 68 may be strengthened mechanically by utilizing a mismatch of the coefficient of thermal expansion between portions of the article to create a compressive stress region and a central region exhibiting a tensile stress. In some embodiments, the glass sheet may be strengthened thermally by heating the glass to a temperature above the glass transition point and then rapidly quenching.

In various embodiments, glass sheet 68 may be chemically strengthened by ion exchange. In the ion exchange process, ions at or near the surface of the glass sheet are replaced by—or exchanged with—larger ions having the same valence or oxidation state. In those embodiments in which the glass sheet comprises an alkali aluminosilicate glass, ions in the surface layer of the article and the larger ions are monovalent alkali metal cations, such as Li⁺, Na⁺, K⁺, Rb⁺, and Cs⁺. Alternatively, monovalent cations in the surface layer may be replaced with monovalent cations other than alkali metal cations, such as Ag⁺ or the like. In such embodiments, the monovalent ions (or cations) exchanged into the glass sheet generate a stress.

Ion exchange processes are typically carried out by immersing a glass sheet in a molten salt bath (or two or more molten salt baths) containing the larger ions to be exchanged with the smaller ions in the glass sheet. It should be noted that aqueous salt baths may also be utilized. In addition, the composition of the bath(s) may include more than one type of larger ions (e.g., Na+ and K+) or a single larger ion. It will be appreciated by those skilled in the art that parameters for the ion exchange process, including, but not limited to, bath composition and temperature, immersion time, the number of immersions of the glass sheet in a salt bath (or baths), use of multiple salt baths, additional steps such as annealing, washing, and the like, are generally determined by the composition of the glass sheet (including the structure of the article and any crystalline phases present) and the desired DOC and CS of the glass sheet that results from strengthening. Exemplary molten bath compositions may include nitrates, sulfates, and chlorides of the larger alkali metal ion. Typical nitrates include KNO₃, NaNO₃, LiNO₃, NaSO₄ and combinations thereof. The temperature of the molten salt bath typically is in a range from about 380° C. up to about 450° C., while immersion times range from about 15 minutes up to about 100 hours depending on glass sheet thickness, bath temperature and glass (or monovalent ion) diffusivity. However, temperatures and immersion times different from those described above may also be used.

In one or more embodiments, the glass sheet 68 may be immersed in a molten salt bath of 100% NaNO₃, 100% KNO₃, or a combination of NaNO₃ and KNO₃ having a temperature from about 370° C. to about 480° C. In some embodiments, the glass sheet may be immersed in a molten mixed salt bath including from about 5% to about 90% KNO₃ and from about 10% to about 95% NaNO₃. In one or more embodiments, the glass sheet may be immersed in a second bath, after immersion in a first bath. The first and second baths may have different compositions and/or temperatures from one another. The immersion times in the first and second baths may vary. For example, immersion in the first bath may be longer than the immersion in the second bath.

In one or more embodiments, the glass sheet may be immersed in a molten, mixed salt bath including NaNO₃ and KNO₃ (e.g., 49%/51%, 50%/50%, 51%/49%) having a temperature less than about 420° C. (e.g., about 400° C. or about 380° C.). for less than about 5 hours, or even about 4 hours or less.

Ion exchange conditions can be tailored to provide a “spike” or to increase the slope of the stress profile at or near the surface of the resulting glass sheet. The spike may result in a greater surface CS value. This spike can be achieved by a single bath or multiple baths, with the bath(s) having a single composition or mixed composition, due to the unique properties of the glass compositions used in the glass sheets described herein.

In one or more embodiments, where more than one monovalent ion is exchanged into the glass sheet, the different monovalent ions may exchange to different depths within the glass sheet (and generate different magnitudes stresses within the glass sheet at different depths). The resulting relative depths of the stress-generating ions can be determined and cause different characteristics of the stress profile.

CS is measured using those means known in the art, such as by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured by those methods that are known in the art, such as fiber and four point bend methods, both of which are described in ASTM standard C770-98 (2013), entitled “Standard Test Method for Measurement of Glass Stress-Optical Coefficient,” the contents of which are incorporated herein by reference in their entirety, and a bulk cylinder method. As used herein CS may be the “maximum compressive stress” which is the highest compressive stress value measured within the compressive stress layer. In some embodiments, the maximum compressive stress is located at the surface of the glass sheet. In other embodiments, the maximum compressive stress may occur at a depth below the surface, giving the compressive profile the appearance of a “buried peak.”

DOC may be measured by FSM or by a scattered light polariscope (SCALP) (such as the SCALP-04 scattered light polariscope available from Glasstress Ltd., located in Tallinn Estonia), depending on the strengthening method and conditions. When the glass sheet is chemically strengthened by an ion exchange treatment, FSM or SCALP may be used depending on which ion is exchanged into the glass sheet. Where the stress in the glass sheet is generated by exchanging potassium ions into the glass sheet, FSM is used to measure DOC. Where the stress is generated by exchanging sodium ions into the glass sheet, SCALP is used to measure DOC. Where the stress in the glass sheet is generated by exchanging both potassium and sodium ions into the glass, the DOC is measured by SCALP, since it is believed the exchange depth of sodium indicates the DOC and the exchange depth of potassium ions indicates a change in the magnitude of the compressive stress (but not the change in stress from compressive to tensile); the exchange depth of potassium ions in such glass sheets is measured by FSM. Central tension or CT is the maximum tensile stress and is measured by SCALP.

In one or more embodiments, the glass sheet may be strengthened to exhibit a DOC that is described as a fraction of the thickness T of the glass sheet (as described herein). For example, in one or more embodiments, the DOC may be in the range of about 0.05 T to about 0.25 T. In some instances, the DOC may be in the range of about 20 μm to about 300 μm. In one or more embodiments, the strengthened glass sheet 68 may have a CS (which may be found at the surface or a depth within the glass sheet) of about 200 MPa or greater, about 500 MPa or greater, or about 1050 MPa or greater. In one or more embodiments, the strengthened glass sheet may have a maximum tensile stress or central tension (CT) in the range of about 20 MPa to about 100 MPa.

Suitable glass compositions for use as glass sheet 68 include soda lime glass, aluminosilicate glass, borosilicate glass, boroaluminosilicate glass, alkali-containing aluminosilicate glass, alkali-containing borosilicate glass, and alkali-containing boroaluminosilicate glass.

Unless otherwise specified, the glass compositions disclosed herein are described in mole percent (mol %) as analyzed on an oxide basis.

In one or more embodiments, the glass composition may include SiO₂ in an amount in a range from about 66 mol % to about 80 mol %. In one or more embodiments, the glass composition includes Al₂O₃ in an amount of about 3 mol % to about 15 mol %. In one or more embodiments, the glass article is described as an aluminosilicate glass article or including an aluminosilicate glass composition. In such embodiments, the glass composition or article formed therefrom includes SiO₂ and Al₂O₃ and is not a soda lime silicate glass.

In one or more embodiments, the glass composition comprises B₂O₃ in an amount in the range of about 0.01 mol % to about 5 mol %. However, in one or more embodiments, the glass composition is substantially free of B₂O₃. As used herein, the phrase “substantially free” with respect to the components of the composition means that the component is not actively or intentionally added to the composition during initial batching, but may be present as an impurity in an amount less than about 0.001 mol %.

In one or more embodiments, the glass composition optionally comprises P₂O₅ in an amount of about 0.01 mol % to 2 mol %. In one or more embodiments, the glass composition is substantially free of P₂O₅.

In one or more embodiments, the glass composition may include a total amount of R₂O (which is the total amount of alkali metal oxide such as Li₂O, Na₂O, K₂O, Rb₂O, and Cs₂O) that is in a range from about 8 mol % to about 20 mol %. In one or more embodiments, the glass composition may be substantially free of Rb₂O, Cs₂O or both Rb₂O and Cs₂O. In one or more embodiments, the R₂O may include the total amount of Li₂O, Na₂O and K₂O only. In one or more embodiments, the glass composition may comprise at least one alkali metal oxide selected from Li₂O, Na₂O and K₂O, wherein the alkali metal oxide is present in an amount greater than about 8 mol % or greater.

In one or more embodiments, the glass composition comprises Na₂O in an amount in a range from about from about 8 mol % to about 20 mol %. In one or more embodiments, the glass composition includes K₂O in an amount in a range from about 0 mol % to about 4 mol %. In one or more embodiments, the glass composition may be substantially free of K₂O. In one or more embodiments, the glass composition is substantially free of Li₂O. In one or more embodiments, the amount of Na₂O in the composition may be greater than the amount of Li₂O. In some instances, the amount of Na₂O may be greater than the combined amount of Li₂O and K₂O. In one or more alternative embodiments, the amount of Li₂O in the composition may be greater than the amount of Na₂O or the combined amount of Na₂O and K₂O.

In one or more embodiments, the glass composition may include a total amount of RO (which is the total amount of alkaline earth metal oxide such as CaO, MgO, BaO, ZnO and SrO) in a range from about 0 mol % to about 2 mol %. In one or more embodiments, the glass composition includes CaO in an amount less than about 1 mol %. In one or more embodiments, the glass composition is substantially free of CaO. In some embodiments, the glass composition comprises MgO in an amount from about 0 mol % to about 7 mol %.

In one or more embodiments, the glass composition comprises ZrO₂ in an amount equal to or less than about 0.2 mol %. In one or more embodiments, the glass composition comprises SnO₂ in an amount equal to or less than about 0.2 mol %.

In one or more embodiments, the glass composition may include an oxide that imparts a color or tint to the glass articles. In some embodiments, the glass composition includes an oxide that prevents discoloration of the glass article when the glass article is exposed to ultraviolet radiation. Examples of such oxides include, without limitation oxides of: Ti, V, Cr, Mn, Fe, Co, Ni, Cu, Ce, W, and Mo.

In one or more embodiments, the glass composition includes Fe expressed as Fe₂O₃, wherein Fe is present in an amount up to 1 mol %. Where the glass composition includes TiO₂, TiO₂ may be present in an amount of about 5 mol % or less.

An exemplary glass composition includes SiO₂ in an amount in a range from about 65 mol % to about 75 mol %, Al₂O₃ in an amount in a range from about 8 mol % to about 14 mol %, Na₂O in an amount in a range from about 12 mol % to about 17 mol %, K₂O in an amount in a range of about 0 mol % to about 0.2 mol %, and MgO in an amount in a range from about 1.5 mol % to about 6 mol %. Optionally, SnO₂ may be included in the amounts otherwise disclosed herein. It should be understood, that while the preceding glass composition paragraphs express approximate ranges, in other embodiments, glass sheet 68 may be made from any glass composition falling with any one of the exact numerical ranges discussed above.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A method of forming a vehicle interior component, comprising:
arranging a glass article on a forming surface, the glass article comprising a first major surface and a second major surface, the first major surface facing the forming surface and the second major surface being opposite to the first major surface, wherein the second major surface comprises a region having a surface free energy of at least 35 mN/m:
applying an adhesive to the region of the second major surface of the glass article:
contacting the adhesive with a frame to attach the frame to the glass article.

2. (canceled)

3. (canceled)

4. The method of claim 1, wherein the glass article comprises a colorant layer and the second major surface is a colorant surface.

5. The method of claim 4, further comprising plasma treating the colorant surface to form the region prior to applying an adhesive.

6. The method of claim 1, wherein the forming surface comprises a first curvature having a first radius of curvature of 50 mm or greater and wherein arranging the glass article on the forming surface comprises bending the glass article over the forming surface such that the first major surface of the glass article conforms to the forming surface and forms a second curvature having a second radius of curvature, the second radius of curvature being within 10% of the first radius of curvature.

7. The method of claim 6, wherein the forming surface comprises a fabricating chuck configured to apply a vacuum pressure through the forming surface to maintain the first major surface in conformity with the forming surface.

8. The method of claim 6, wherein the frame comprises a curved support surface defining a third radius of curvature, the third radius of curvature being within 10% of the first radius of curvature or the second radius of curvature, and wherein the frame is configured to maintain the second curvature of the glass article after the glass article is removed from the forming surface.

9. The method of claim 1, further comprising the step of plasma treating the second major surface of the glass article prior to applying the adhesive.

10. The method of claim 9, wherein plasma treating comprises scanning a nozzle through which plasma is discharged over the second major surface of the glass article to produce the region.

11. The method of claim 10, comprising placing the nozzle at a working distance of 2 mm to 10 mm from the second major surface, wherein scanning the nozzle over the second major surface is performed at a speed of 10 mm/s to 90 mm/s, wherein the plasma treating is performed at a power of 10 W to 2000 W, wherein the plasma treating is performed using argon and oxygen at an oxygen to argon ratio of 0.1% to 5%.

12. (canceled)

13. (canceled)

14. (canceled)

15. (canceled)

16. (canceled)

17. (canceled)

18. The method of claim 1, wherein no chemical primer is used on the second major surface of the glass article prior to applying the adhesive.

19. The method of claim 1, wherein the adhesive comprises a shear strength of at least 4.5 MPa as measured by ASTM D1002 for a single lap joint, wherein the adhesive experiences cohesive failure during testing according to ASTM D1002.

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. A vehicle interior component, comprising:
a glass article comprising a first major surface and a second major surface, the second major surface being opposite to the first major surface, wherein the second major surface comprises a region with a surface free energy of at least 35 mN/m;
an adhesive layer directly contacting the region of the glass article; and
a frame attached to the second major surface of the glass article by the adhesive layer.

32. The vehicle interior component of claim 31, wherein the second major surface of the glass article is plasma-treated.

33. The vehicle interior component of claim 31, wherein the frame comprises a curved support surface defining a curvature having a radius of curvature of 50 mm or greater and wherein the frame is configured to hold the glass article in a curved configuration when the glass article is attached to the frame.

34. (canceled)

35. The vehicle interior component of claim 31, wherein the adhesive comprises a shear strength of at least 4.5 MPa as measured by ASTM D1002 for a single lap joint.

36. The vehicle interior component of claim 35, wherein the adhesive experiences cohesive failure during testing according to ASTM D1002.

37. The vehicle interior component of claim 31, comprising no chemical primer applied to the second major surface.

38. (canceled)

39. The vehicle interior component of claim 31, wherein the glass article comprises a glass sheet and a colorant layer disposed on the glass sheet and wherein the second major surface comprises a colorant surface of the colorant layer.

40. The vehicle interior component of claim 39, wherein the colorant layer comprises a thickness of 1 μm to 20 μm.

41. The vehicle interior component of claim 31, wherein the glass sheet comprises a thickness of 0.3 mm to 2 mm.

42. (canceled)
